(19) United States
(12) Patent Application Publication
(10) Pub. No.: US 2023/0325126 A1
(43) Pub. Date: Oct. 12, 2023

(54) INFORMATION PROCESSING APPARATUS AND METHOD AND NON-TRANSITORY COMPUTER READABLE MEDIUM

(71) Applicant: FUJIFILM Business Innovation Corp., Tokyo (JP)

(72) Inventor: Kohshiro INOMATA, Kanagawa (JP)

(73) Assignee: FUJIFILM Business Innovation Corp., Tokyo (JP)

(21) Appl. No.: 17/939,255

(22) Filed: Sep. 7, 2022

(30) Foreign Application Priority Data
Mar. 28, 2022 (JP) 2022-052342

(51) Int. Cl. G06F 3/12

(52) U.S. Cl. CPC G06F 3/1208; G06F 3/1206; G06F 3/1256

(57) ABSTRACT

An information processing apparatus includes a processor configured to: generate a screen that is converted into a data format which allows a portion of a first image of a printed material to be corrected, the portion being a portion related to a region specified by a user; and generate, in response to setting of content of a correction received via the screen, a second image having reflected the set content of the correction therein.

### CROSS-REFERENCE TO RELATED APPLICATIONS

This application is based on and claims priority under 35 use 119 from Japanese Patent Application No. 2022-052342 filed Mar. 28, 2022.

### BACKGROUND

### (I) Technical Field

The present disclosure relates to an information processing apparatus and method and a non-transitory computer readable medium.

### (II) Related Art

When a user gets a printed material output from a printer, he/she may find an error, such as a typographical error, in the printed material. In this case, the user is required to correct the error and then to perform reprinting. If the user is in the office, he/she returns to his/her seat, corrects an error, goes to a place where the printer is located, and then obtains a reprinted material from the printer.

Japanese Unexamined Patent Application Publication No. 2014-191562 discloses the following technology. When a user makes a correction to a printed material output from a printer obtained in response to an instruction provided from a mobile terminal, he/she can do correction work on an operation panel of the printer to correct image data used for printing.

### SUMMARY

According to the technology disclosed in the above-described publication, however, a user can make a correction to a printed material by using a printer only when the user has provided a print instruction to the printer by using a mobile terminal of the user. If the user does not have the mobile terminal when making a correction with the printer or if the user has provided a print instruction from a terminal at his/her desk, he/she is unable to do correction work by using this technology.

Additionally, according to this technology, after displaying image data of a portion to be corrected on the mobile terminal, the user is required to transfer the image data to the printer. If there are many portions to be corrected, transferring image data is time-consuming for the user.

Aspects of non-limiting embodiments of the present disclosure relate to making it possible to decrease the time from when an error is found in a printed material and is corrected until the printed material is reprinted, compared with a case in which document data is resent to a printer to correct an error in a printed material with the printer.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to: generate a screen that is converted into a data format which allows a portion of a first image of a printed material to be corrected, the portion being a portion related to a region specified by a user; and generate, in response to setting of content of a correction received via the screen, a second image having reflected the set content of the correction therein.

### BRIEF DESCRIPTION OF THE DRAWINGS

Exemplary embodiments of the present disclosure will be described in detail based on the following figures, wherein:

FIG. 1 is a conceptual diagram illustrating an image forming system according to a first exemplary embodiment;

FIG. 2 is a block diagram illustrating an example of the hardware configuration of an image forming apparatus;

FIG. 3 illustrates examples of data stored in an auxiliary storage of the image forming apparatus;

FIG. 4 is a block diagram illustrating an example of the functional configuration of the image forming apparatus used in the first exemplary embodiment;

FIG. 5 is a conceptual diagram for explaining a processing operation from when a print job is sent until a printed material is output for the first time;

FIG. 6 is a flowchart illustrating an example of a processing operation from when a print job is received until a printed material is output for the first time;

FIG. 7 is a conceptual diagram for explaining a scene where it is necessary to correct a printed material;

FIGS. 8A and 8B illustrate examples in which a region to be corrected is specified;

FIG. 9 is a flowchart illustrating an example of a processing operation from when a scanned image is detected until a corrected printed material is reprinted;

FIG. 10 illustrates a conceptual diagram for explaining the relationship between a specified region and a related portion;

FIG. 11 illustrates an example of an HTML page generated in step S18 of FIG. 9;

FIGS. 12A and 12B illustrate display examples of an HTML page;

FIG. 13 illustrates an example of a screen which presents a correction candidate similar to or related to a correction reflected in document data;

FIG. 14 illustrates a case in which a region to be corrected is an image;

FIG. 15 illustrates another example of an HTML page generated in step S18 of FIG. 9;

FIG. 16 illustrates an example of a screen on which a correction can be made;

FIG. 17 illustrates an example in which an operation screen of the image forming apparatus is displayed on a display of a mobile user terminal;

FIG. 18 is a flowchart illustrating an example of a processing operation executed by the image forming apparatus according to a second exemplary embodiment;

FIG. 19 illustrates an example in which the selection of a region to be corrected is received on a screen of a display;

FIG. 20 illustrates another example in which the selection of a region to be corrected is received on the screen of the display;

FIGS. 21A and 21B are conceptual diagrams illustrating an image forming system according to a third exemplary embodiment; and

FIG. 22 illustrates an example of the hardware configuration of a storage.

### DETAILED DESCRIPTION

Exemplary embodiments of the disclosure will be described below with reference to the accompanying drawings.

### First Exemplary Embodiment

### (System Configuration)

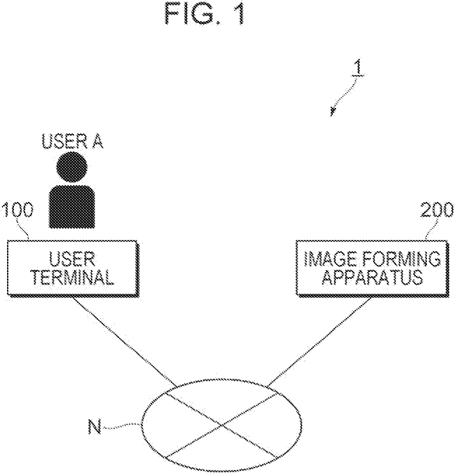

FIG. 1 is a conceptual diagram illustrating an image forming system 1 according to a first exemplary embodiment.

The image forming system 1 shown in FIG. 1 includes a user terminal 100 and an image forming apparatus 200 connected to each other via a network N.

The network N is a local area network (LAN), the internet, or a mobile communication system, such as 4G or 5G. The network N is not limited to a wired network and may be a wireless network.

In FIG. 1, one user terminal 100 and one image forming apparatus 200 are connected to the network N. However, plural user terminals 100 and plural image forming apparatuses 200 may be connected to the network N.

The user terminal 100 is a computer operated by a user A. The user terminal 100 may be a stationary computer or a portable computer.

The stationary computer is also called a desktop computer.

There are various types of portable computers, such as tablet, laptop, head-mounted, glasses, wearable, mobile computers. Examples of the mobile computer are a cellular phone, a smartphone, and a tablet.

The user A can use plural user terminals 100.

The user terminal 100 has a function of sending a print job to the image forming apparatus 200.

A print job is a job that provides an instruction to print a document. One print job includes a data file of a document to be printed (hereinafter such a file will also be called document data). The format of document data may be any type of format.

There are two types of document data. One is a digital document generated by using an application program (hereinafter may also be called an app), and the other is a digitized document generated from a paper document.

Examples of the digital document are digital data generated by using office apps, drawing apps, and accounting apps and webpages displayed with website apps, that is, browsers.

Examples of the digitized document are digital data output from a scanner and that from a camera, for example.

The image forming apparatus 200 is an apparatus that forms an image on a sheet of paper or another type of medium. The image forming apparatus 200 dedicated to the formation of images (hereinafter called printing) is also called a printer.

The image forming apparatus 200 may be an apparatus having multiple functions, such as a copy function of producing a copy of a document, a scanner function of optically reading an image of a document, and a fax function, in addition to a print function. The image forming apparatus 200 having multiple functions is also called a multifunction device.

The image forming apparatus 200 may be an apparatus for business use or an apparatus for home use.

The image forming apparatus 200 is an example of an information processing apparatus.

### (Configuration of Image Forming Apparatus 200)

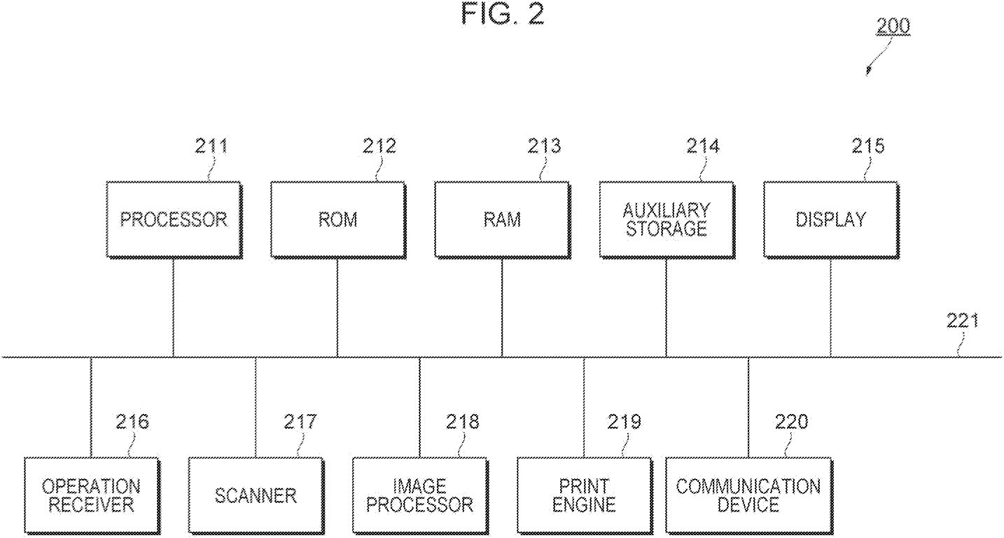

FIG. 2 is a block diagram illustrating an example of the hardware configuration of the image forming apparatus 200.

The image forming apparatus 200 shown in FIG. 2 includes a processor 211, a read only memory (ROM) 212, a random access memory (RAM) 213, an auxiliary storage 214, a display 215, an operation receiver 216, a scanner 217, an image processor 218, a print engine 219, and a communication device 220. The processor 211 controls the entire operation of the image forming apparatus 200. In the ROM 212, basic input/output system (BIOS) and other programs are stored. The RAM 213 is used as a work area for the processor 211. The auxiliary storage 214 stores image data and print data, for example. The display 215 displays a user interface. The operation receiver 216 receives a user operation. The scanner 217 reads an image of a document. The image processor 218 executes processing, such as color correction and tone correction, on image data. The print engine 219 prints an image on a sheet of paper or another type of medium. The communication device 220 implements communication with the network N. The processor 211 is connected to the other elements via a communication path 221.

The processor 211, the ROM 212, and the RAM 213 function as a computer.

The processor 211 implements various functions by executing a program. One of the functions is a function of receiving a correction made to a printed document. With this function, the processor 211 can generate a screen converted into a data format in which only a portion of data related to a region specified by a user can be corrected.

As the auxiliary storage 214, a hard disk drive (HDD) or a semiconductor memory is used. In the auxiliary storage 214, various types of data related to print jobs are stored.

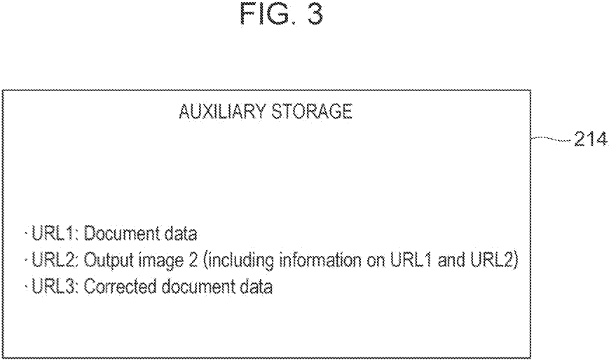

FIG. 3 illustrates examples of data stored in the auxiliary storage 214 of the image forming apparatus 200 (see FIG. 2).

In the first exemplary embodiment, the storage locations of data in the auxiliary storage 214 are managed by using uniform resource locators (URLs).

In FIG. 3, “URL1” represents a storage location of “document data” corresponding to a print job.

“URL2” represents a storage location of “Output image 2” used for outputting a printed material. “Output image 2” is an output image generated by embedding information on “URL1” and “URL2” into “Output image 1”, which is a document to be printed.

“URL3” represents a storage location of “Corrected document data”. “Corrected document data” is document data in which the content of a correction is reflected. In the first exemplary embodiment, “correction” is received by the image forming apparatus 200 after the image forming apparatus 200 outputs a printed material.

Referring back to FIG. 2, the display 215 is a liquid crystal display or an organic electroluminescence (EL) display, for example. On the display 215, an operation screen is displayed. An example of the operation screen is a home screen. Another example of the operation screen is a screen for receiving a correction for an error, such as a typographical error, or a print image prepared for printing. The display 215 that displays an operation screen is an example of an operation unit.

The operation receiver 216 may be constituted by physical switches and buttons and a capacitive touch sensor, for example, disposed on the surface of the display 215. A device integrating the display 215 and the operation receiver 216 is called a touchscreen.

The scanner 217 reads an image of a document. There are two modes in which an image of a document is read. One is that a document is fixed and a reader is moved to read an image of the document. The other is that a reader is fixed and reads an image of a moving document. The scanner 217 supports both of the modes.

The image processor 218 is constituted by a dedicated processor or processing circuit, for example, for processing image data and print data.

The print engine 219 is a device that forms an image on a medium, such as a sheet of paper, and is constituted by a mechanism in accordance with the print method employed for the image forming apparatus 200. As a recording medium, toner or ink, for example, is used.

The communication device 220 is a device that implements communication with the network N and is constituted by a module in compliance with a wired or wireless communication standard.

The communication path 221 is a signal line or a bus.

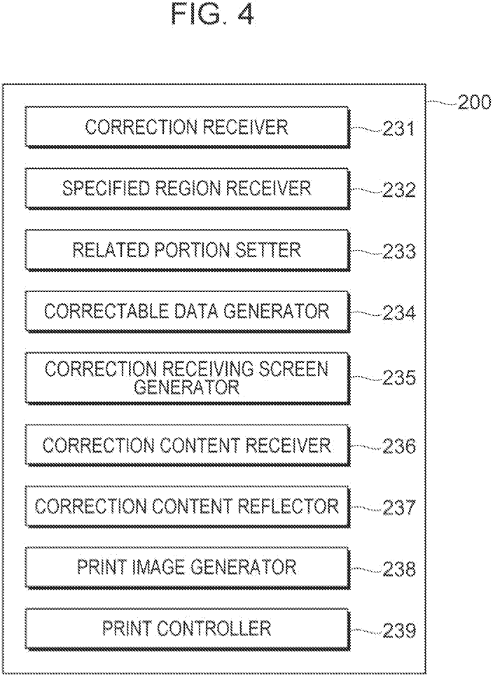

FIG. 4 is a block diagram illustrating an example of the functional configuration of the image forming apparatus 200 used in the first exemplary embodiment.

The functions shown in FIG. 4 are implemented as a result of the processor 211 (see FIG. 2) executing a program.

The functions shown in FIG. 4 are a correction receiver 231, a specified region receiver 232, a related portion setter 233, a correctable data generator 234, a correction receiving screen generator 235, a correction content receiver 236, a correction content reflector 237, a print image generator 238, and a print controller 239.

The correction receiver 231 is a function of receiving a correction made to a printed document. The correction receiver 231 receives a correction made to a printed document via a home screen or another operation screen.

The specified region receiver 232 is a function of receiving a region specified by a user (hereinafter also called a specified region). A specified region corresponds to a character, a character string, or an image. A user may specify one region or plural regions. The specified region receiver 232 receives a specified region by reading the position of a mark included in a scanned image, for example. Examples of a mark are an underline, a circle, and a check mark.

The related portion setter 233 is a function of setting a portion related to a specified region (hereinafter may also be called a related portion).

The related portion is a partial region containing a specified region and is set based on the specified region. The related portion is set to improve the efficiency of correction work. For example, if the length of a character string is reduced by deleting a misspelled word, multiple lines following this character string may be influenced by this correction. Conversely, if the length of a character string is increased as a result of making a correction, multiple lines following this character string may also be influenced by this correction.

Additionally, as a result of making a correction, a user may also want to change the expression of a portion before a specified region, depending on the content of the correction. For example, it may become necessary to change active voice to passive voice or vice versa or to correct a subject or a preposition.

In the first exemplary embodiment, a related portion is set so that related corrections can be received at one time.

In the first exemplary embodiment, the related portion setter 233 sets, as a related portion, a line including a specified region or a line corresponding to the specified region and plural lines positioned above and below or before and after the line including the specified region or the line corresponding to the specified region.

Nevertheless, a related portion may be restricted to a line including a specified region or to a range of a line including a specified region and plural lines positioned below or after the line including the specified region. The number of lines forming a range of a related portion may be determined in advance.

The related portion setter 233 may set a sentence, a paragraph, a subsection, a section, or a chapter, for example, including a specified region as a related portion.

A range of a related portion set by the related portion setter 233 may be changed by a user.

The correctable data generator 234 is a function of generating data in a data format in which the data can be corrected based on an output image corresponding to the related portion. In other words, the correctable data generator 234 converts document data into a format in which only part of “Output image 2” used for outputting a printed material can be corrected. For example, the correctable data generator 234 generates a Hypertext Markup Language (HTML) document. The HTML document is a text document in which individual elements are delineated by tags to define the structure of the document. The HTML document is an example of a structured document.

If, for example, text of an output image is appended with text information, the correctable data generator 234 reads text information appended to a related portion. Examples of the extension of this type of output image are “pdf” and “xdw”.

If text information is not appended to text of an output image, the correctable data generator 234 performs optical character recognition (OCR) processing on a related portion of the output image so as to generate text information.

In the first exemplary embodiment, OCR processing is executed as part of the function of the correctable data generator 234.

Alternatively, OCR processing may be executed by an external terminal connected to the network N. In this case, the correctable data generator 234 supplies the output image of a related portion to an external terminal and receives the OCR processing result from the external terminal.

Examples of the extension of the type of output image without text information are “png” and “jpeg”.

If a specified region is expressed by an image, the correctable data generator 234 reads one or plural images registered as substitute image candidates that may be able to replace the image of the specified region.

In the first exemplary embodiment, it is assumed that logos and marks, such as company logos and marks, are used as substitute images. It is not realistic to register all the images that may be used as substitute images. Hence, images that are found to be frequently mistaken for another image on an empirical basis may be registered.

These substitute images are read regardless of the type of image specified by a user. Nevertheless, if the type of image specified by a user is a logo, for example, images only related to logos may be read.

As described above, a correction that can be received after printing is restricted to a correction made to a related portion. This decreases the load on calculation resources, compared with when document data is converted into a data format in which the entirety of a printed material can be corrected.

Additionally, as a result of restricting data that can be corrected to a related portion, the time taken for the user A to make a correction is decreased, in other words, the user A uses the image forming apparatus 200 only for a short time.

The correction receiving screen generator 235 is a function of generating a screen used for receiving a correction (hereinafter also called a correction receiving screen).

In the first exemplary embodiment, the correction receiving screen is constituted by data in a data format in which a related portion can be corrected and “Output image 1” corresponding to a region surrounding this data. Here, “Output image 1” may not necessarily be a region completely surrounding the data (related portion), that is, a region including top, bottom, left, and right areas of the data (related portion), but may be a region partially surrounding the data (related portion), that is, a region including at least part of preceding, subsequent, top, bottom, left, and right areas of the data (related portion).

As discussed above, “Output image 1” is not a portion to be corrected by a user. “Output image 1” is used to understand a context, for example, that is difficult to understand only with a related portion. Nonetheless, the correction receiving screen may be constituted only by a related portion. The correction receiving screen may be generated as an HTML page, for example.

The correction content receiver 236 is a function of receiving a correction made to a correction receiving screen from a user.

If a related portion includes a character string, the correction content receiver 236 receives a correction made to an HTML document corresponding to the related portion.

If a related portion includes an image, the correction content receiver 236 receives the selection of one of substitute image candidates that may replace the image in the related portion. It is not desirable that a user corrects the image in the related portion on the operation screen of the image forming apparatus 200 in terms of the operability and the operation time. The correction content receiver 236 thus receives the selection of a registered substitute image to replace the image of a related portion.

The correction content reflector 237 is a function of reflecting the content of a received correction in the corresponding document data. If a correction made to an HTML document is received, the correction content reflector 237 replaces the corresponding portion of the document data used for printing a printed material by the corrected HTML document.

If the selection of a substitute image to replace the image in the related portion is received, the correction content reflector 237 replaces the corresponding portion of the document data used for printing a printed material by this substitute image.

The corrected document data is stored in “URL3” in the auxiliary storage 214 (see FIG. 3).

The print image generator 238 is a function of generating a print image from document data having reflected the content of a correction therein (hereinafter such document data may also be called corrected document data). In the first exemplary embodiment, a print image generated from the corrected document data is called “Output image 3”.

The print controller 239 is a function of controlling the execution of printing based on a generated print image. As a result of the print controller 239 controlling the execution of printing, a modified printed material in which an error, such as a typographical error, is corrected is output from the image forming apparatus 200.

### (Processing Operation)

### (Processing From Sending of Print Job Until First Output of Printed Material)

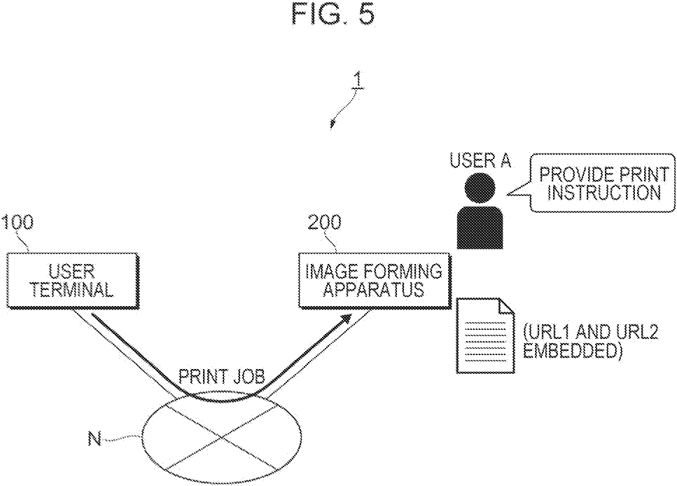

FIG. 5 is a conceptual diagram for explaining a processing operation from when a print job is sent until a printed material is output for the first time. In FIG. 5, the elements corresponding to those in FIG. 1 are designated by like reference numerals.

A print job is sent from the user terminal 100 to the image forming apparatus 200. The print job includes document data.

In the first exemplary embodiment, the print job is stored in the image forming apparatus 200 until the user A having moved to the image forming apparatus 200 provides a print instruction. Alternatively, the image forming apparatus 200 may execute the print job upon receiving it.

In the example in FIG. 5, the user A having moved to the image forming apparatus 200 provides a print instruction, and the print job is executed and a printed material is output.

In the first exemplary embodiment, “URL2” representing the storage location of “Output image 2” and “URL1” representing the storage location of document data used for generating “Output image 2” are embedded into the printed material. “URL1” and “URL2” may be printed on the surface of the printed material as characters, barcode, quick response (QR) code (registered trademark), or small dot images.

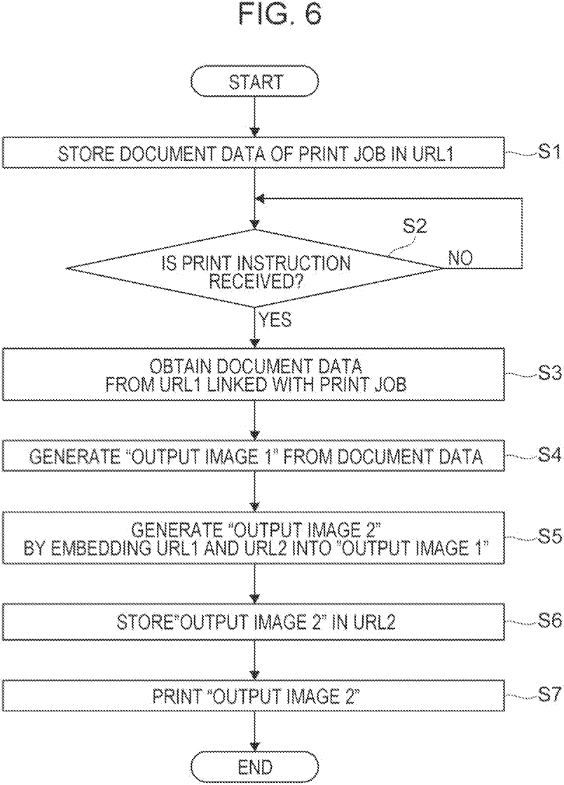

FIG. 6 is a flowchart illustrating an example of a processing operation from when a print job is received until a printed material is output for the first time. “S” in FIGS. 6, 9, and 18 stands for a step. The processing operation shown in FIG. 6 is implemented as a result of the processor 211 (see FIG. 2) executing a program.

In step S1, upon receiving a print job by the processor 211, document data included in the print job is stored in URL1. URL1 represents the storage location of the document data in the auxiliary storage 214 (see FIG. 3).

Then, in step S2, the processor 211 judges whether a print instruction is received.

If the user A has not provided a print instruction, the result of step S2 becomes NO. While the result of step S2 is NO, the processor 211 repeats step S2.

If the user has provided a print instruction, the result of step S2 becomes YES.

Then, in step S3, the processor 211 obtains the document data from URL1 linked with the print job.

Then, in step S4, the processor 211 generates “Output image 1” from the document data.

In step S5, the processor 211 generates “Output image 2” by embedding URL1 and URL2 into “Output image 1”.

In step S6, the processor 211 stores “Output image 2” in URL2.

Then, in step S7, the processor 211 prints “Output image 2”.

### (Correction to Printed Material)

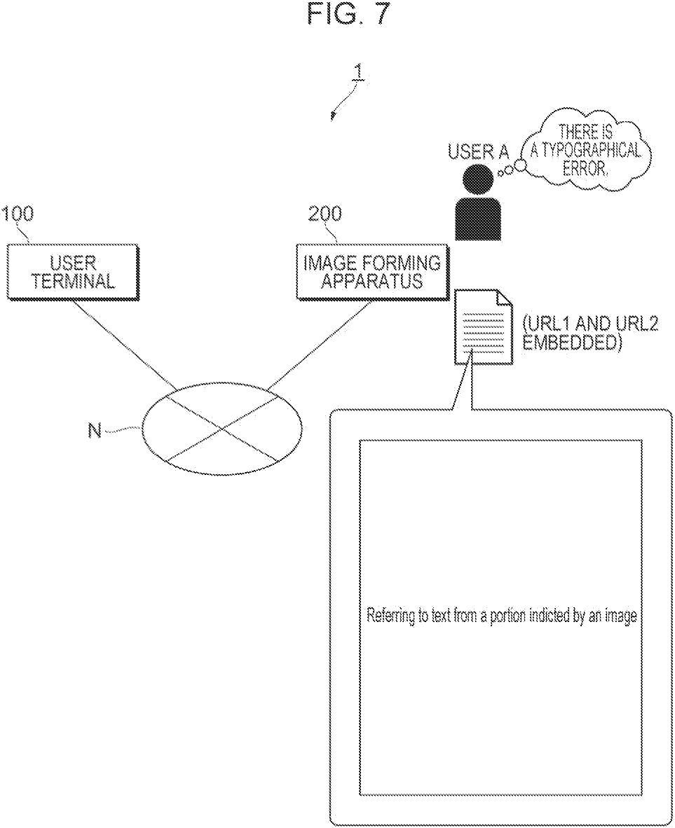

FIG. 7 is a conceptual diagram for explaining a scene where it is necessary to correct a printed material. In FIG. 7, the elements corresponding to those in FIG. 5 are designated by like reference numerals.

In the example of FIG. 7, the user A has found a typographical error in a printed material. In FIG. 7, the image of a page including the typographical error is shown in an enlarged size. Only a line including the typographical error is shown in the page.

On the page in FIG. 7, “Referring to text from a portion indicted by an image” is written, where “indicted” is a typographical error.

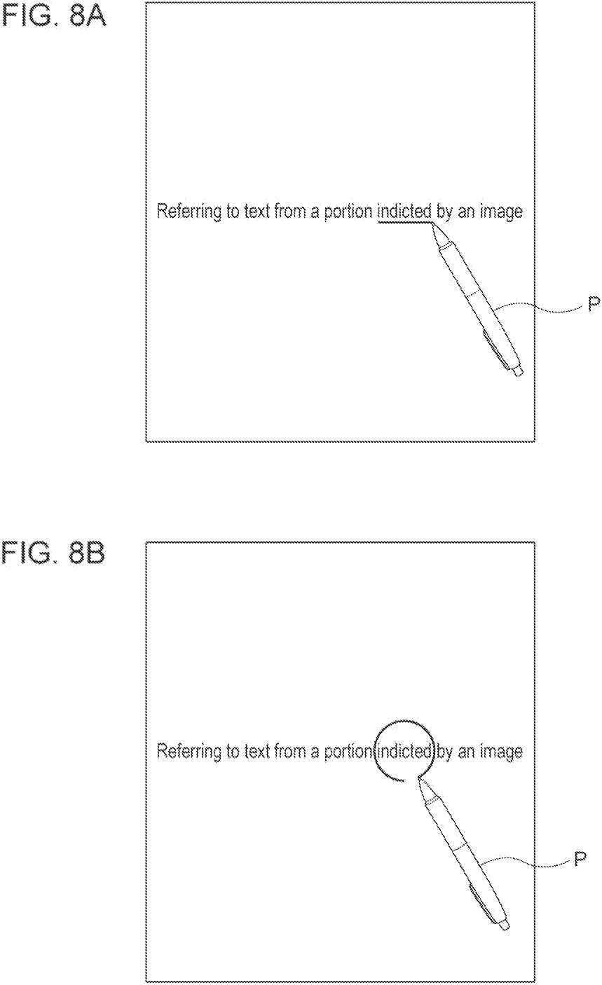

FIGS. 8A and 8B illustrate examples in which a region to be corrected is specified. FIG. 8A shows an example in which a region to be corrected is underlined. FIG. 8B shows an example in which a region to be corrected is circled. The printed material shown in FIGS. 8A and 8B is the same material as that in FIG. 7.

In the example in FIG. 8A, a user has underlined “indicted” with a pen P. In the example in FIG. 8B, the user has circled “indicted” with a pen P.

A user may specify a region to be corrected in a manner different from those in FIGS. 8A and 8B. For example, a region to be corrected may be specified with a check mark or rectangular border lines or border lines in another shape.

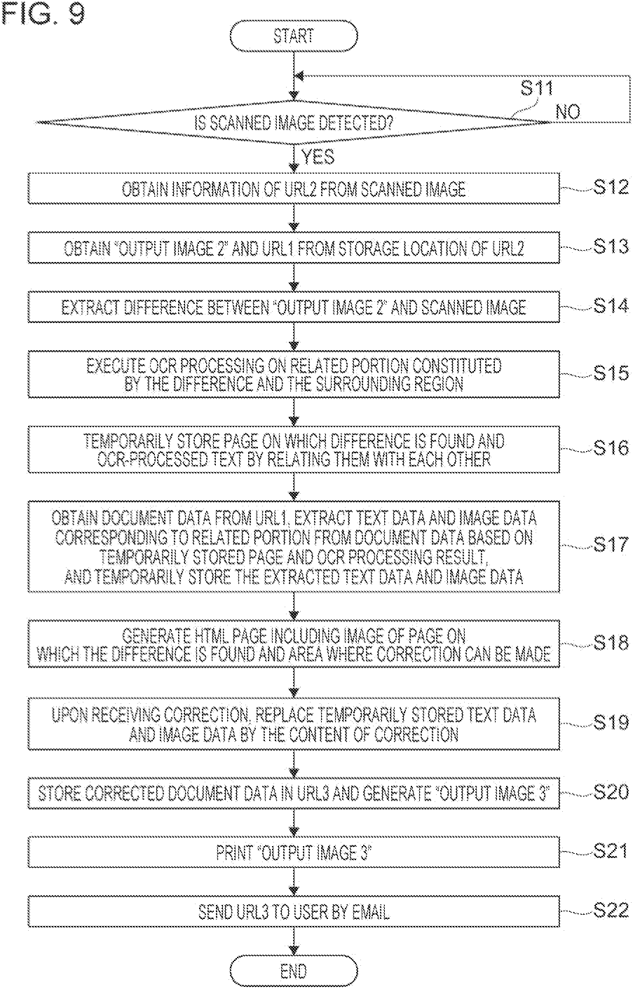

FIG. 9 is a flowchart illustrating an example of a processing operation from when a scanned image is detected until a corrected printed material is reprinted. The processing operation shown in FIG. 9 is implemented as a result of the processor 211 (see FIG. 2) executing a program.

The processing operation shown in FIG. 9 is started when “making a correction after printing”, for example, is selected on the home screen or when “making a correction after printing”, for example, is selected on a screen showing an execution log. In the example in FIG. 9, the user A has selected the use of a scanned image to specify a region to be corrected when selecting “making a correction after printing”.

The user A may mark a region to be corrected before selecting “making a correction after printing” or after selecting it.

After receiving “making a correction after printing”, the processor 211 judges in step S11 whether a scanned image output from the scanner 217 (see FIG. 2) is detected.

If a scanned image is not detected, the result of step S11 becomes NO. While the result of step S11 is NO, the processor 211 repeats step S11.

When a scanned image is detected, the result of step S11 becomes YES.

Then, in step S12, the processor 211 obtains information of URL2 from the scanned image. URL2 is information indicating the storage location of “Output image 2” used for generating a printed material and is embedded in the printed material.

Then, in step S13, the processor 211 obtains “Output image 2” and URL1 from the storage location of URL2. “Output image 2” is an example of a first image.

In step S14, the processor 211 extracts a difference between “Output image 2” and the scanned image. The region corresponding to the difference is a specified region.

Then, in step S15, the processor 211 executes OCR processing on a related portion constituted by the difference and the region around this difference.

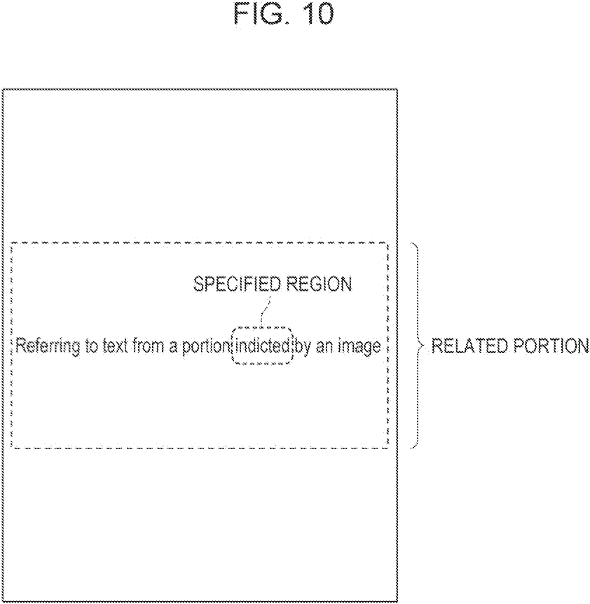

FIG. 10 illustrates a conceptual diagram for explaining the relationship between the specified region and the related portion. The printed material shown in FIG. 10 is the same as the printed material shown in FIG. 7. The image shown in FIG. 10 corresponds to “Output image 2”.

In the example in FIG. 10, the range corresponding to the specified region is indicated by the broken lines. The line including the specified region and a few lines positioned each of above and below the line including the specified region are set as the related portion. Text included in the related portion is converted into text data by OCR processing.

Referring back to FIG. 9, in step S16, the processor 211 temporarily stores the page on which the difference is found and OCR-processed text by relating them with each other. The page on which the difference is found can be identified by checking it against “Output image 2”.

In step S17, the processor 211 obtains document data from URL1 obtained in step S13. Based on the temporarily stored page and OCR processing result, the processor 211 extracts text data and image data corresponding to the related portion from the document data, and then temporarily stores the extracted text data and image data.

The OCR-processed text stored in step S16 is used for extracting the corresponding data portion from the document data. As a result of step S17, the image data and text data corresponding to the related portion are extracted from the document data, which is the original of the printed material to be corrected.

Then, in step S16, the processor 211 generates an HTML page including the image of the page on which the above-described difference is found and an area where a correction can be made. The area where a correction can be made includes the image and text corresponding to the related portion. The page corresponds to the image of the same page of “Output image 2” without the related portion.

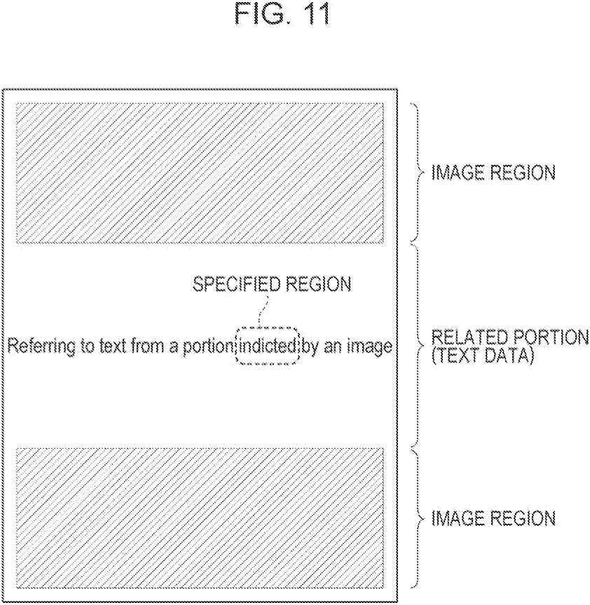

FIG. 11 illustrates an example of the HTML page generated in step S18. Image regions located to surround the related portion are displayed outside the related portion. Here, the image regions (“Output image 1”) may not necessarily be regions completely surrounding the related portion, that is, regions including top, bottom, left, and right areas of the related portion, but may be regions partially surrounding the related portion, that is, regions including at least part of preceding, subsequent, top, bottom, left, and right areas of the related portion. This HTML page is an example of a screen converted into a data format in which data can be corrected. The area where a correction can be made corresponds to a related portion.

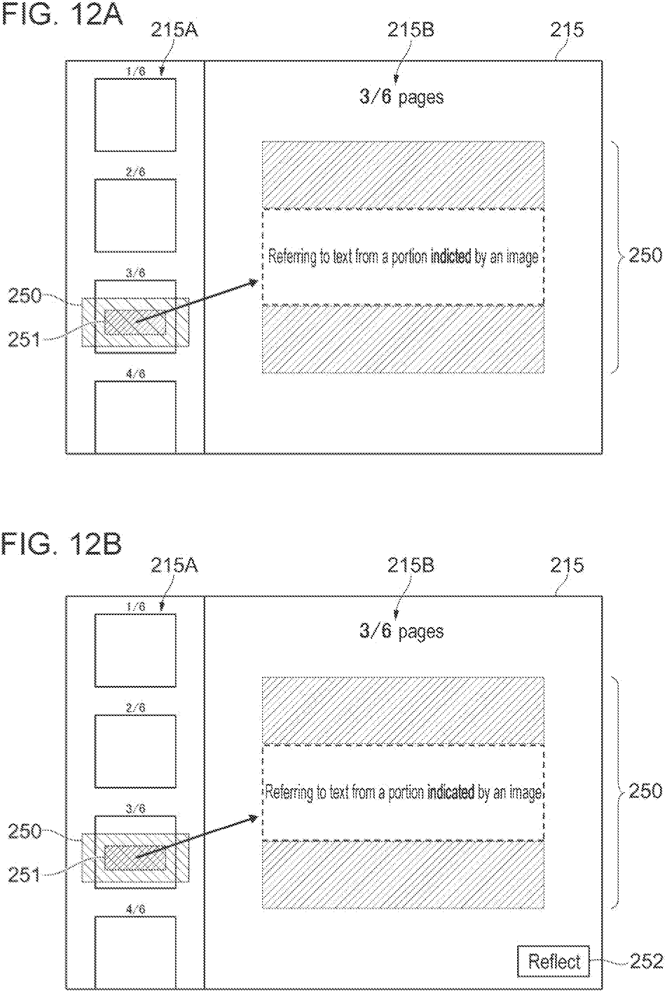

FIGS. 12A and 12B illustrate display examples of the HTML page. In the example of FIG. 12A, an error is not yet corrected. In the example of FIG. 12B, an error is corrected.

The operation screen in FIGS. 12A and 12B is displayed on the display 215 of the image forming apparatus 200 (see FIG. 1). The operation screen shown in FIGS. 12A and 12B is also an example of the screen converted into a data format in which data can be corrected.

The operation screen in FIGS. 12A and 12B is constituted by partial screens 215A and 215B.

On the partial screen 215A, thumbnail images of the individual pages of document data are displayed, and also, the position of the page displayed on the partial screen 215B and the position of the displayed portion in this page are indicated.

The partial screen 215A shows that the document data is constituted by six pages and the page to be corrected is the third page.

In the thumbnail image of the third page, the range of the displayed portion on the partial screen 215B is indicated by a hatched portion 250. In this thumbnail image, a portion that can be corrected within this range is indicated by a hatched portion 251.

The display content of the partial screen 215B shown in FIG. 12A is the same as the HTML page shown in FIG. 11. As shown in FIG. 12A, on the partial screen 215B, the related portion and the surrounding images are only displayed. Here, the surrounding images (“Output image 1”) may not necessarily be images completely surrounding the related portion, that is, images including top, bottom, left, and right areas of the related portion, but may be images partially surrounding the related portion, that is, images including at least part of preceding, subsequent, top, bottom, left, and right areas of the related portion. Displaying only the related portion and the surrounding images decreases the calculation resources required for displaying the HTML page and also shortens the time taken to display the HTML page.

The user A corrects a typographical error on the operation screen shown in FIG. 12A. The operation screen shown in FIG. 12B is a screen after the user A has corrected the typographical error. In FIG. 12B, “indicted” is corrected to “indicated”.

On the partial screen 215B in FIG. 12B, a button 252 is displayed to set the correction made on the operation screen in FIG. 12A. In the example in FIG. 12B, the character string (word) “Reflect” is indicated on the button 252. Upon detecting that the button 252 is operated, the processor 211 (see FIG. 2) reflects the content of the correction in the document data.

If there are plural specified regions, “Next” or “To next editing screen”, for example, may be indicated on the button 252.

If there is no other specified region, “Store” or “Reprint”, for example, may be indicated on the button 252 instead of “Reflect”.

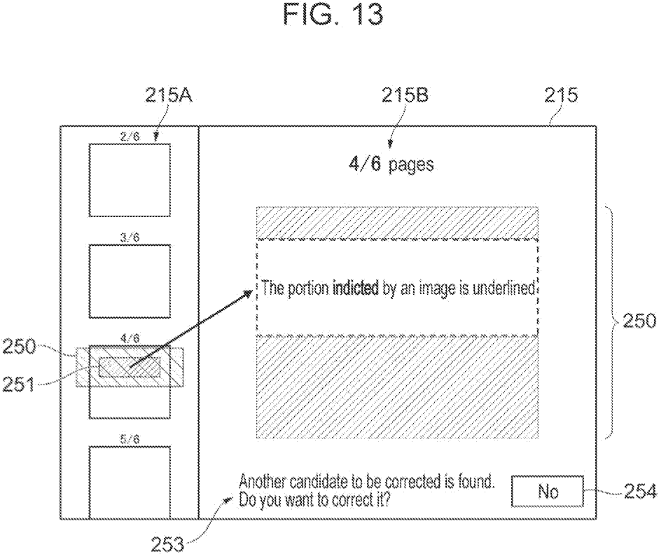

FIG. 13 illustrates an example of a screen which presents a correction candidate similar to or related to the correction reflected in the document data. In FIG. 13, the elements corresponding to those in FIGS. 12A and 12B are designated by like reference numerals.

The screen shown in FIG. 13 is displayed when a portion including the same character string (word) as that reflected in the document data is found. For instance, the screen is displayed when the character string (word) “indicted” is found in another portion of the document data.

In the example in FIG. 13, a phrase “The portion indicted by an image is underlined” is found on the fourth page of the document data. On the partial screen 215B, a question 253 to a user is displayed: “Another candidate to be corrected is found. Do you want to correct it?”. This candidate is not what the user A has specified, and “No” is indicated on a button 254. If the user A has corrected “indicted” in the phrase of this candidate, “No” is switched to “Reflect” on the button 254.

Depending on the content of a correction, many candidates to be corrected may be found. Hence, a search may be conducted by including character strings positioned before and after a corrected character or a corrected character string. For instance, in the example in FIG. 12A, a search may be conducted by using “from a portion indicted by” as a search key. In this example, three words (character string) before the corrected word and one word (character string) after the corrected word are included in the search key. Including character strings (words) positioned before and after a corrected character or a corrected character string can reliably detect the same or similar word or expression that may be overlooked by a user.

A corrected character or character string and a preceding character string may be used as a search key. A corrected character or character string and a following character string may be used as a search key.

This type of search key may not be able to detect some candidates similar to a corrected character or character string. To address this issue, if a corrected character string (word) has a form of another part of speech, such as if a corrected character string (word) is a noun and has a verb form, this verb form may be included in a search key.

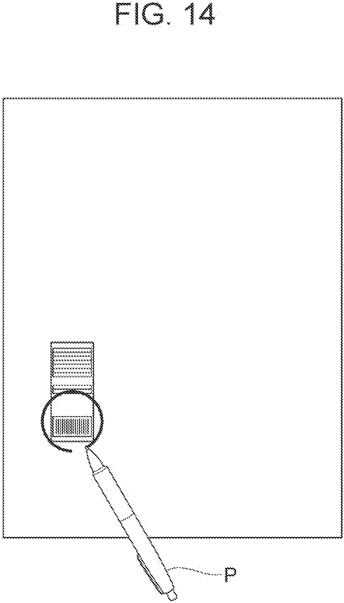

FIG. 14 illustrates a case in which a region to be corrected is an image. In FIG. 14, the elements corresponding to those in FIGS. 8A and 8B are designated by like reference numerals. In the example in FIG. 14, the user circles the image with a pen P.

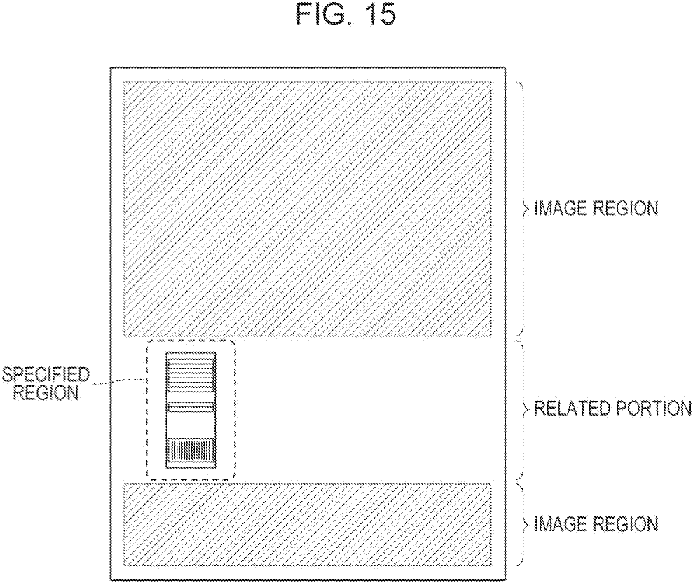

FIG. 15 illustrates another example of the HTML page generated in step S18. In FIG. 15, the elements corresponding to those in FIG. 11 are designated by like reference numerals.

In the example in FIG. 15, a region to be corrected is an image, and the image specified by a user is a specified region. In the example in FIG. 15, the line including the specified region is set as a related portion. This related portion in FIG. 15 is only an example, and a range of the line including the specified region and a few lines each of above and below the specified region may be included in the related portion, as in a case in which a portion to be corrected is text. If text is included in a specified region, an HTML page may be displayed in a data format in which the text can be edited.

In the example in FIG. 15, image regions are displayed above and below the related portion.

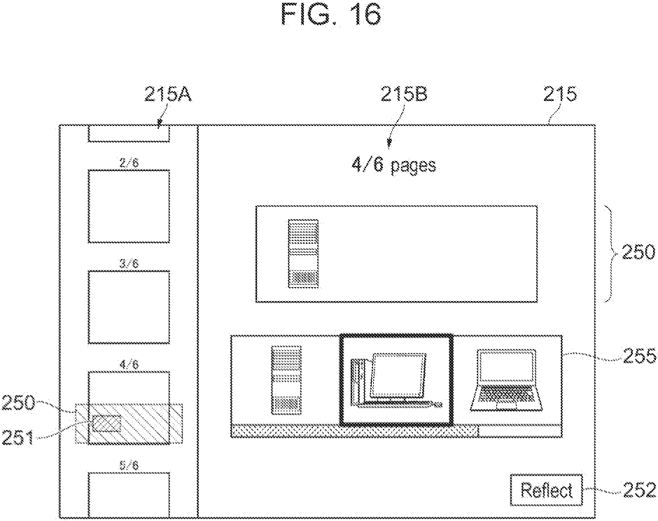

FIG. 16 illustrates an example of a screen on which a correction can be made. In FIG. 16, the elements corresponding to those in FIGS. 12A and 12B are designated by like reference numerals.

The operation screen in FIG. 16 is also constituted by partial screens 215A and 215B, as those in FIGS. 12A and 12B. In the operation screen in FIG. 16, the fourth page of document data is a page to be corrected.

When an image is to be corrected, it is not realistic to start an image handling app and to correct the image on the operation screen. On the operation screen in FIG. 16, a selection field 255 is displayed near the related portion to present substitute image candidates that may replace the image in the related portion.

In FIG. 16, three images are displayed as substitute image candidates. The intermediate image is selected as a substitute image. When a button 252 is operated in this state, the image in the specified region is replaced by the selected image and the resulting document data is generated.

The operation screen displayed on the image forming apparatus 200 (see FIG. 1) is a screen to be used by operating a set of buttons arranged on the operation screen. Because of the set of buttons on the screen, a page of document data to be corrected may not be contained on the screen. If the page is displayed in a reduced size, it may be difficult for a user to do correction work.

Additionally, if there are many errors to be corrected, the user A spends a lot of time doing correction work by using the image forming apparatus 200, which may influence other users who want to use the image forming apparatus 200 to do printing or other work.

Under such circumstances, in the first exemplary embodiment, the operation screen may also be displayed on a user terminal carried by the user A.

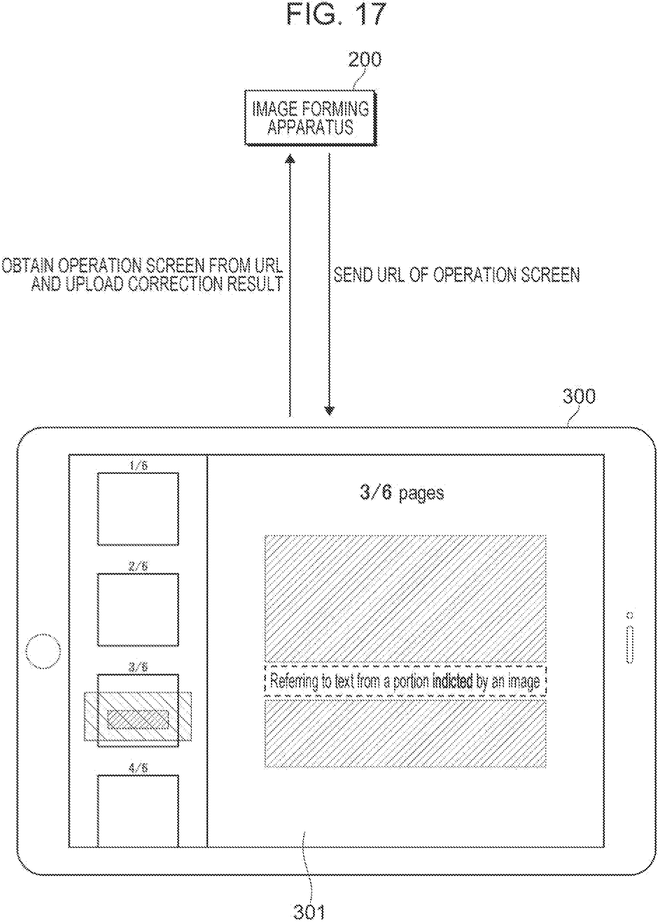

FIG. 17 illustrates an example in which the operation screen of the image forming apparatus 200 is displayed on a display 301 of a mobile user terminal 300. The display 301 is an example of an operation unit.

In the example of FIG. 17, a tablet computer having a large display area is used as the mobile user terminal 300. It may be possible to use a smartphone as the mobile user terminal 300 if the smartphone has a larger display screen than the operation panel of the image forming apparatus 200. If the user A wishes, the operation screen of the image forming apparatus 200 may be displayed on the mobile user terminal 300 regardless of the size of the display surface of the mobile user terminal 300.

The hardware configuration of the mobile user terminal 300 may be equivalent to that of the image forming apparatus 200 shown in FIG. 2 from which the scanner 217, the image processor 218, and the print engine 219 are removed.

Examples of the operation screens illustrated in FIGS. 12A through 16 are each linked with a specific URL and managed by the image forming apparatus 200. The mobile user terminal 300 is thus required to obtain a specific URL from the image forming apparatus 200. By obtaining and accessing the specific URL, the mobile user terminal 300 can display the operation screen of the image forming apparatus 200 on the display.

The URL may be sent from the image forming apparatus 200 to the mobile user terminal 300 by an email addressed to the email address of the user A or by a short message addressed to the telephone number of the user A. Alternatively, the URL may be sent to the mobile user terminal 300 by using near field communication (NFC) (registered trademark), Bluetooth (registered trademark), a wireless LAN, or other communication media in compliance with the corresponding communication standards.

Alternatively, barcode or QR code representing the URL may be displayed on the operation screen of the image forming apparatus 200, and the mobile user terminal 300 may read the barcode or the QR code to access the URL.

Referring back to FIG. 9, in step S19, upon receiving a correction on the HTML page used as the operation screen, the processor 211 replaces the extracted text data and image data temporarily stored in step S17 by the content of the correction. The extracted text data and image data corresponds to the related portion.

Then, in step S20, the processor 211 stores the corrected document data in URL3 and generates “Output image 3”. “Output image 3” is an example of a second image.

In step S21, the processor 211 prints “Output image 3”.

There are different approaches to printing “Output image 3”.

One approach is to printing a corrected page only. This approach can be employed when the content of the correction does not influence the following pages. For example, if the number of characters of a character string to be corrected is the same as that of the corrected character string, only the corrected page is printed. In the above-described example, “indicted” is corrected to “indicated”. The word “indicated” is longer than “indicted” by only one letter, and it is likely that the correction does not influence the following pages and only the page including this correction can be reprinted.

Another approach is to printing a corrected page and the following page onwards. This approach is employed when the content of the correction influences the following page onwards. For example, if the number of characters of a character string to be corrected is different from that of the corrected character string, the content of the final line of the corrected page may be different from that of the same page before correction. For example, the content of the final line of the page before correction may shift to the head of the next page after correction, or the first line of the next page before correction may shift to the final line of the corrected page.

Depending on the print mode, the reprinting range may become different.

For example, if a printed material to be corrected is subjected to binding processing, all pages are to be reprinted.

If N-up printing is employed, that is, if multiple pages are printed on the same side of a sheet, at least a page to be printed on the same side of a sheet as the corrected page is to reprinted. For example, in a print mode in which two pages are arranged on one sheet, if the third page is corrected, the third and fourth pages are to be reprinted. In this case, the correction made on the third page may influence the fourth page. If the correction on the third page does not influence beyond the fourth page, the reprinting range is restricted to the third and fourth pages. If the correction on the third page influences the fifth page onwards, the third page through the fifth page onwards are to be reprinted.

In the case of duplex printing in which both sides of a sheet are used for printing, at least a page paired with a corrected page is to be reprinted. For example, in a print mode in which one page is allocated to the front side of one sheet of paper and another page is allocated to the back side of the same sheet, if the third page is corrected, the third and fourth pages are to be reprinted. As in N-up printing, the correction made on the third page may influence the fourth page. If the correction on the third page does not influence beyond the fourth page, the reprinting range is restricted to the third and fourth pages. If the correction on the third page influences the fifth page onwards, the third page through the fifth page onwards are to be reprinted.

The reprinting range may be determined by the processor 211. Alternatively, the user A may set the reprinting range.

After or during the execution of reprinting, in step S22, the processor 211 sends URL3 to the user A by email, for example. URL3 is sent to the user terminal 100. However, if the mobile user terminal 300 is used, URL3 may be sent to the mobile user terminal 300.

URL3 representing the storage location of the document data having reflected the content of the correction is sent to the user terminal 100 or the mobile user terminal 300. This enables the user A to reuse this document data. Without URL3, the user A would be required to correct the document data used in the print job all over again.

### Second Exemplary Embodiment

In a second exemplary embodiment, when a user finds an error, such as a typographical error, in a printed material, he/she may specify a region to be corrected in a manner different from the first exemplary embodiment.

In the second exemplary embodiment, the image forming system 1 (see FIG. 1) used in the first exemplary embodiment is also used. In the second exemplary embodiment, an explanation of the same portions as those in the first exemplary embodiment will be omitted, while portions different from the first exemplary embodiment will be described.

A description will be given below, assuming that the user A having moved to the image forming apparatus 200 finds an error, such as a typographical error, in a printed material output from the image forming apparatus 200 and instructs the image forming apparatus 200 to correct the error.

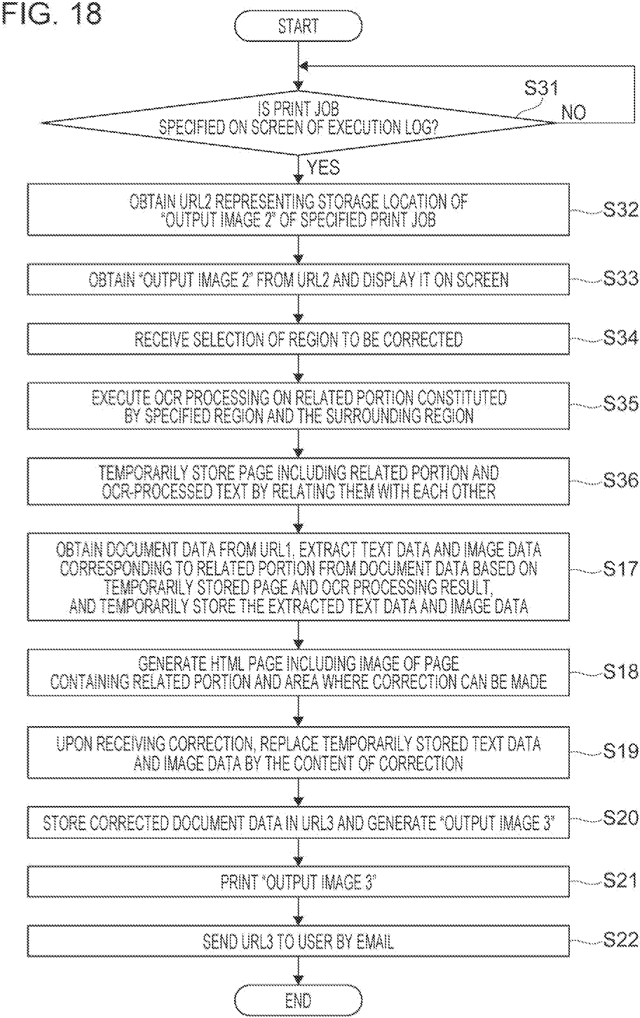

FIG. 18 is a flowchart illustrating an example of a processing operation executed by the image forming apparatus 200 according to the second exemplary embodiment. Steps corresponding to those in FIG. 9 are designated by like step numbers. The processing operation in FIG. 18 is also implemented as a result of the processor 211 (see FIG. 2) executing a program.

The processing operation in FIG. 18 is started when “making a correction after printing”, for example, is selected on the home screen or when “making a correction after printing”, for example, is selected for a print job specified from a log list of executed print jobs.

In step S31, the processor 211 judges whether a print job is specified on the screen of an execution log.

If a print job is not specified, the result of step S31 becomes NO. While the result of step S31 is NO, the processor 31 repeats step S31.

If a print job is specified, the result of step S31 becomes YES.

Then, in step S32, the processor 211 obtains URL2, which represents the storage location of “Output image 2” of the specified print job.

Then, in step S33, the processor 211 obtains “Output image 2” from URL2 and displays it on the screen.

In step S34, the processor 211 receives the selection of a region to be corrected.

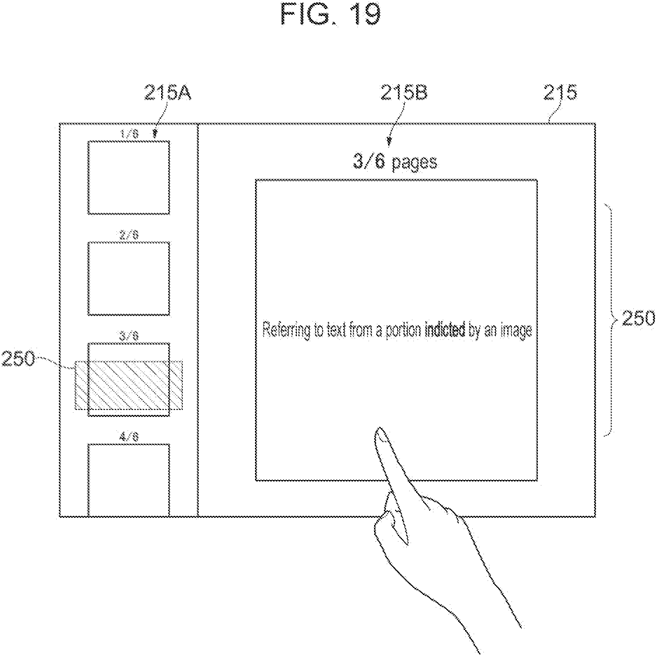

FIG. 19 illustrates an example in which the selection of a region to be corrected is received on the screen of the display 215. In FIG. 19, the elements corresponding to those in FIGS. 12A and 12B are designated by like reference numerals. The screen shown in FIG. 19 is a screen for specifying a region to be corrected and is different from that of FIGS. 12A and 12B displayed after a region to be corrected is detected.

In the partial screen 215B, a region including a line “Referring to text from a portion indicted by an image” and a surrounding portion on the third page is displayed. Here, the surrounding portion (“Output image 1”) may not necessarily be a portion completely surrounding the line (related portion), that is, a portion including top, bottom, left, and right areas of the line (related portion), but may be a portion partially surrounding the line (related portion), that is, a portion including at least part of preceding, subsequent, top, bottom, left, and right areas of the line (related portion). Since the screen in FIG. 19 is a screen displayed before a region to be corrected is specified, only the hatched portion 250 indicating the range of the displayed portion on the partial screen 215B is shown on the partial screen 215A.

In the example of FIG. 19, the user A is trying to tap a portion to be corrected with a finger.

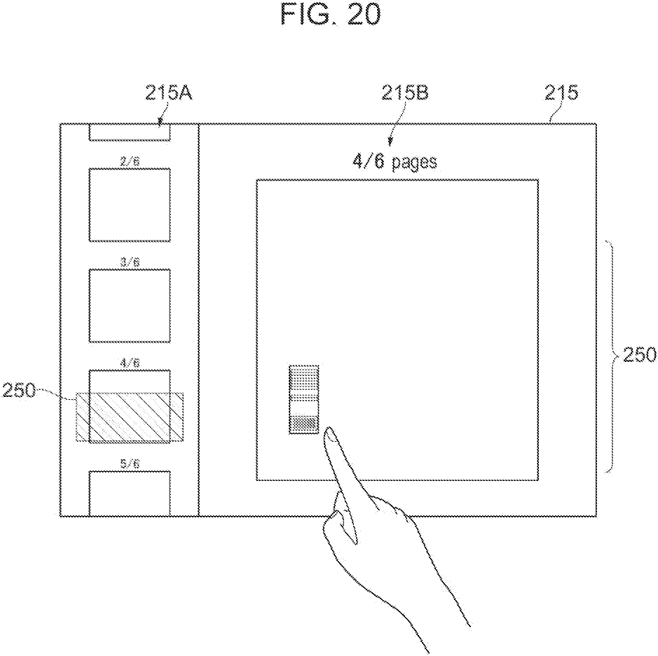

FIG. 20 illustrates another example in which the selection of a region to be corrected is received on the screen of the display 215. In FIG. 20, the elements corresponding to those in FIG. 16 are designated by like reference numerals. As in the screen in FIG. 19, the screen shown in FIG. 20 is a screen for specifying a region to be corrected and is thus different from that of FIG. 16 displayed after a region to be corrected is detected.

In the example in FIG. 20, the fourth page is displayed in the partial screen 215B. In the example of FIG. 20, the user A is trying to tap an image to be corrected with a finger.

Referring back to FIG. 18, in step S35, the processor 211 executes OCR processing on the related portion constituted by the specified region and the surrounding region.

Then, in step S36, the processor 211 temporarily stores a page including the related portion and OCR-processed text by relating them with each other.

The subsequent steps are similar to those in the first exemplary embodiment. That is, steps S17 through S22 in FIG. 9 are sequentially executed.

In the second exemplary embodiment, a typographical error or another type of error may be corrected by operating the operation screen displayed on the display 215 (see FIG. 2) of the image forming apparatus 200. This makes it possible for a user to do correction work for an error after printing even if the image forming apparatus 200 is not equipped with the scanner 217 (see FIG. 2).

### Third Exemplary Embodiment

In a third exemplary embodiment, another system configuration will be discussed. In the third exemplary embodiment, an explanation of the same portions as those in the first exemplary embodiment will be omitted, while portions different from the first exemplary embodiment will be described.

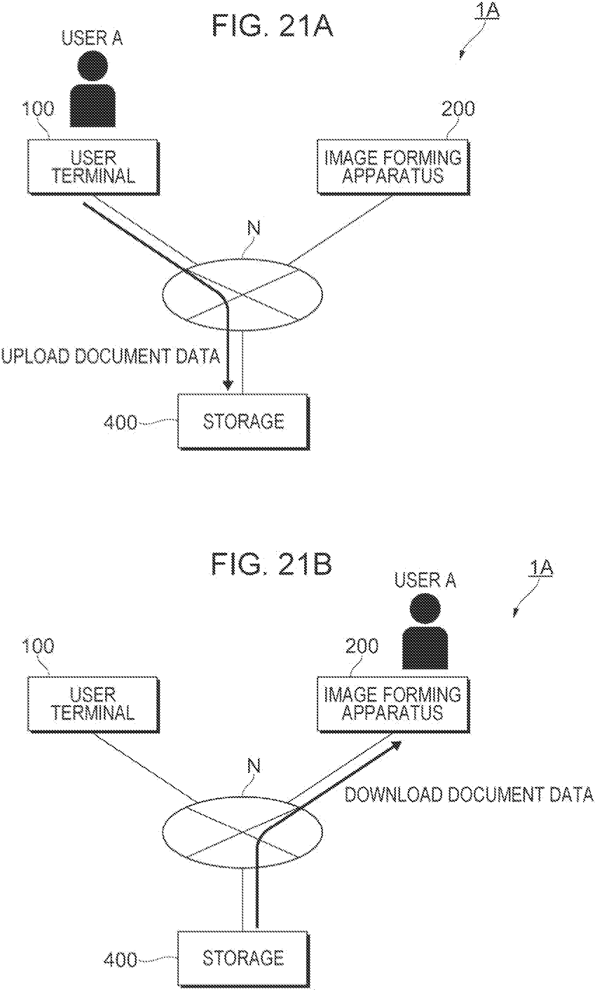

FIGS. 21A and 21B are conceptual diagrams illustrating an image forming system 1A according to the third exemplary embodiment. FIG. 21A shows a data flow before printing. FIG. 21B shows a data flow when printing is started. In FIGS. 21A and 21B, the elements corresponding to those in FIG. 1 are designated by like reference numerals.

The image forming system 1A shown in FIGS. 21A and 21B includes a storage 400, which serves as an external device of the image forming apparatus 200. The storage 400 is a device for storing print jobs or document data and is constituted by an HDD or a semiconductor memory, for example.

In the third exemplary embodiment, the storage 400 may not necessarily be a device dedicated to storing print jobs or document data. The storage 400 may be a file server, a print server, or a document managing server, for example. The storage 400 may be a cloud-based server or an on-premise server.

FIG. 21A shows a scene where document data, for example, is uploaded from the user terminal 100 to the storage 400. FIG. 21B shows a scene where the user A having moved to the image forming apparatus 200 downloads document data, for example, to start printing.

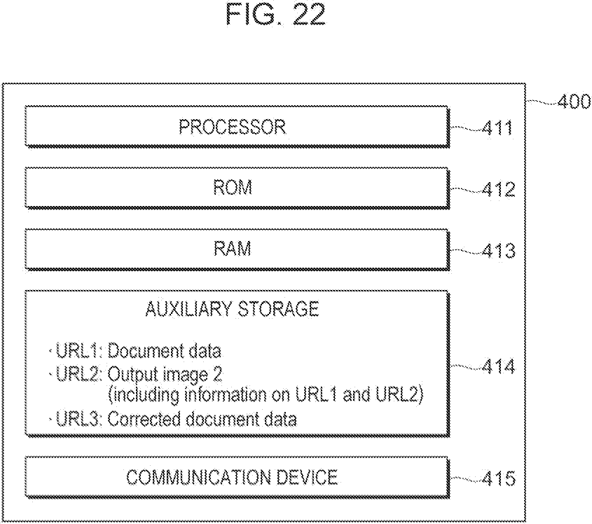

FIG. 22 illustrates an example of the hardware configuration of the storage 400.

The storage 400 shown in FIG. 22 includes a processor 411 that controls the entire operation of the storage 400, a ROM 412 in which BIOS and other programs are stored, a RAM 413 used as a work area for the processor 411, an auxiliary storage 414 that stores print jobs or document data, for example, and a communication device 415 that performs communication with external devices.

The processor 41, the ROM 412, and the RAM 413 function as a computer. The processor 411 implements various functions by executing a program. For example, the processor 411 stores and outputs various items of printing-related data in collaboration with the image forming apparatus 200.

As the auxiliary storage 414, an HDD or a semiconductor memory, for example, is used. In the third exemplary embodiment, the storage locations of data are managed by URLs.

In the auxiliary storage 414 shown in FIG. 22, various items of data are stored. In “URL1”, “document data” received from the user terminal 100 is stored. “Document data” may include document data contained in a print job.

In “URL2”, “Output image 2” received from the image forming apparatus 200 is stored. “Output image 2” includes information on “URL1” and “URL2”.

In “URL3”, “Corrected document data” received from the image forming apparatus 200 is stored.

In the third exemplary embodiment, the user A can use a desired image forming apparatus 200 connected to the network N to output a printed material.

Output images and corrected document data do not remain in the image forming apparatus 200, thereby enhancing the security of document data.

### Other Exemplary Embodiments

In the above-described exemplary embodiments, the functions relating to receiving and making a correction after printing, that is, all the functions shown in FIG. 4, are provided in the image forming apparatus 200. However, some of the functions may be executed by a computer which operates in collaboration with the image forming apparatus 200. For example, some of the functions may be disposed in the storage 400 (see FIGS. 21A and 21B) which operates in collaboration with the image forming apparatus 200. In this case, the storage 400 may be used as an example of the information processing apparatus.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
generate a screen that is converted into a data format which allows a portion of a first image of a printed material to be corrected, the portion being a portion related to a region specified by a user; and
generate, in response to setting of content of a correction received via the screen, a second image having reflected the set content of the correction therein.

2. The information processing apparatus according to claim 1, wherein the processor is configured to set, as the portion related to the region specified by the user, the region specified by the user and an area adjacent to the region.

3. The information processing apparatus according to claim 2, wherein the processor is configured to display, in response to specifying of a character or a character string as the region, the portion related to the region and the first image corresponding to an area surrounding the portion related to the region.

4. The information processing apparatus according to claim 2, wherein the processor is configured to display, in response to specifying of a certain image as the region, a registered image as a candidate image which replaces the certain image such that the registered image is selectable.

5. The information processing apparatus according to claim 1, wherein the processor is configured to display or send information which is used for displaying the screen on an operation unit of an external terminal.

6. The information processing apparatus according to claim 1, wherein the processor is configured to display the screen on an operation unit of an image forming apparatus that outputs the second image.

7. The information processing apparatus according to claim 1, wherein the processor is configured to search for another region related to the content of the correction and to present the region related to the content of the correction as another candidate to be corrected.

8. The information processing apparatus according to claim 1, wherein the processor is configured to reflect the content of the correction in document data corresponding to the first image and to store the document data.

9. The information processing apparatus according to claim 8, wherein the processor is configured to send information for reading the document data having reflected the content of the correction therein to an external terminal.

10. The information processing apparatus according to claim 1, wherein the processor is configured to set, as pages to be reprinted, not only a first page to which the correction is made, but also a second page which follows the first page and which is influenced by the correction made to the first page.

11. The information processing apparatus according to claim 1, wherein the processor is configured to set, as pages to be reprinted, all pages that are influenced by the correction due to a setting set for printing the printed material.

12. A non-transitory computer readable medium storing a program causing a computer to execute a process, the process comprising:
generating a screen that is converted into a data format which allows a portion of a first image of a printed material to be corrected, the portion being a portion related to a region specified by a user; and
generating, in response to setting of content of a correction received via the screen, a second image having reflected the set content of the correction therein.

13. An information processing method comprising:
generating a screen that is converted into a data format which allows a portion of a first image of a printed material to be corrected, the portion being a portion related to a region specified by a user; and
generating, in response to setting of content of a correction received via the screen, a second image having reflected the set content of the correction therein.
